(19) United States
(12) Patent Application Publication
(10) Pub. No.: US 2022/0178466 A1
(43) Pub. Date: Jun. 9, 2022

(54) Abnormal Condition Detection On Shut Down Valve And Blow Down Valve

(71) Applicant: Ideation AS, Hovik (NO)

(72) Inventors: Knut Are Dyrdal, Bekkjarvik (NO); Arne Ole Roald, JAR (NO)

(21) Appl. No.: 17/310,190

(22) PCT Filed: Jan. 27, 2020
(86) PCT No.: PCT/NO2020/050013

§ 371 Date: Jul. 23, 2021

(30) Foreign Application Priority Data
Jan. 25, 2019 (NO) 20190092

(51) Int. Cl. F16K 37/00

(52) U.S. Cl. CPC F16K 37/0041; F16K 37/005

(57) ABSTRACT

It is described a system for detecting abnormal operating conditions in a shutdown valve (SDV (1)), said shutdown valve (SDV (1)) comprising an inlet pipe (5), an outlet pipe (6), a flow-controlling element (2) located between said inlet and outlet pipes, a stem (3) connected to the flow-controlling element (2) driven by an actuator arrangement (4), the system further including a first detector system for detecting stiction of the flow-controlling element (2), including a first predictor (20) connected to the stem (3), detecting the position of the flow-controlling element (2) transferred through the stem (3), and a second detector system for detecting a leak in the flow-controlling element (2), including a second predictor (40) for detecting vibrations in the flow-controlling element.

### FIELD OF THE INVENTION

The present invention relates to the monitoring of changes in stiction, wear and tear and the presence of leaks which will influence functional safety of Shut Down Valves and Blow Down Valves.

### BACKGROUND

A Shutdown Valve, SDV, also referred to as Process Shutdown Valve, PSDV or Emergency Shutdown Valve, ESDV or ESV, is an actuated valve designed to stop the flow of a hazardous fluid upon the detection of a dangerous event. Blow Down Valves (BDV's) are designed to depressurize a process system in case of a detected hazardous situation on the plant.

BDV's are shut in normal operations and must have high integrity for opening when a process blow-down is required. Both SDV's and BDV's provide protection against possible harm to people, environment and the investments. SDV's and BDV's form part of a Safety Instrumented System. The process of providing automated safety protection upon the detection of a hazardous event is called Functional Safety.

SDV's and BDV's are primarily associated with the oil and gas industry, although other industries may also require this type of protection system.

In a process plant in operation, both SDV's and BDV's are “static” valves, which stay in one position until a hazardous condition occurs, where an automated shut down is required and the SDV's all closes, and/or a process depressurisation is required and the BDV's all open.

SDV's and BDV's are typically high-recovery valves that lose little energy due to low flow turbulence. Flow paths are straight through. As SDV's and BDV's form part of an automated safety instrumented system it is necessary to operate the valve by means of an actuator. These actuators are normally fail-safe with either a pneumatic cylinder or a hydraulic cylinder.

In addition to the fluid type, actuators also vary in the way energy is stored to operate the valve on demand such as single-acting cylinder with spring return where the energy is stored by means of a compressed spring. Another type is double-acting cylinder, where the “fail safe” energy is stored using a volume of compressed fluid from external accumulators.

The type of actuation required depends upon the application (pressure and flow), site facilities and the physical space available, although the majority of actuators for smaller SDV's and BDV's are of the spring return type due to the failsafe nature of spring return systems, while larger valves may have hydraulic double-acting actuators with separate hydraulic accumulators for back-up power to make up the failsafe requirement.

SDV's and BDV's are used in a variety of industrial applications to safeguard process equipment for exposure of internal pressures exceeding the equipment design pressure. One industrial application where SDV's and BDV's are used is within the oil and gas industry.

Consequences of a fault on any one shutdown valve ranges from hazardous explosions and fire to releases of hydrocarbon and other toxic gases to the atmosphere.

Maintenance of SDV's and BDV's are of major importance to the economy in the operation. In the maintenance context, it is distinguished between (REF. NORSOK Z008 and others): “corrective maintenance” where the equipment is run to failure, “preventive maintenance” where maintenance of the equipment is performed at pre-defined (planned) intervals and “condition-based maintenance” where maintenance is performed based on measurements of equipment condition and performance.

SDV's and BDV's are normally maintained on predefined intervals in the class of “preventive maintenance”. Reducing maintenance time and costs associated with maintaining SDV's and BDV's can have a large impact on the plant maintenance cost.

For SDV's and BDV's used in safety instrumented systems it is essential to know that the valve can provide the required level of safety performance and that the valve will operate on demand. The required level of performance is dictated by the Safety Integrity Level (SL). In order to adhere to this level of performance it is necessary to test the valve.

There are 2 types of testing methods available, namely:

Proof test—A manual test that allows the operator to determine whether the valve is in “as good as new” condition by testing for all possible failure modes. This will require a plant shutdown.

Diagnostic test—An automated on-line test that will detect a percentage of the possible failure modes of the shutdown valve. An example of this for a shutdown valve would be a partial stroke test, which is a technique used in a control system to allow the user to test a percentage of the possible failure modes of a shutdown valve without the need to physically close the valve.

Partial stroke test is used to assist in determining that the safety function will operate on demand by moving the valve some degree from open or closed at specified time intervals. The idea is to test the valve without interrupting the process. However, the test measures actuator pressure and time and is therefore only an indirect measure of valve movement related to stiction of the shutdown valve.

Partial stroke testing introduces additional components directly connected to the hydraulic/pneumatic actuator system of the shutdown valve adding components and complexity, which may reduce the probability of failure on demand which is an essential measure for a safety system and not a replacement for the need to fully stroke valves, as proof testing is still a mandatory requirement.

Other systems for automated online monitoring of SDV's and BDV's include continuous on-line monitoring connected to the plant monitoring system, which create a huge amount of data to be analysed and evaluated, which has proven to create costly installations and require specialised personnel to maintain and extract the data for the PSV maintenance process. One obvious opportunity for test of SDV's and BDV's integrity is unplanned plant shutdowns, caused by equipment, instrument or human failure or caused by a real hazardous situation such as a fire or gas leak on the plant.

However, due to the nature of the shutdown and the need to bring the plant back to normal production, testing SDV's and BDV's in this operational transient, unplanned situations are complicated tasks which need special equipment, which is not readily available on the market or far too expensive to install using existing instrument systems.

### SUMMARY

It is an object of the invention to provide a system and method to detect abnormal operating conditions which will influence functional safety of Shut Down Valves (SDV's) or Blow Down Valves (BDV's) by monitoring valve performance as part of the normal operation of the plant, which also include spurious process shutdowns.

It is further an object of the invention to provide a method and system in order to reduce maintenance work and operating cost for the SDV's.

### Stiction;

It is further an object of the invention to provide a method and a system to measure stiction of the valve when it is activated by any spurious process shutdown where the valve control system moves the SDV from open to closed or from closed to open position.

### Wear and Tear:

It is further an object of the invention to provide a method and system to determine when the valve dynamic movement envelope is changed due to corrosion and wear and tear of the mechanical parts of SDV's.

### Check of Leak and Leak Flow Rate;

It is further an object of the invention to provide a method and system to determine when the SDV deviates from the acceptable operating specification by leaking process medium and to quantify the leak rate per unit time when the SDV is closed.

### Actuator Pressure:

It is further an object of the invention to provide a method to determine when the valve dynamic movement envelope of the SDV is changed due to changes in the actuator supply pressure dynamic.

A further object of the invention is to provide a method and system to determine when the SDV's deviate from the acceptable operating specification by valve leakage in closed position and to quantify the leak rate per unit time.

Yet a further object of the invention is to generate, and store defined abnormal condition messages in real time in the local predictor microcontroller and to transmit the messages wireless as required by external operational data systems.

These objects are achieved with the method and system of the disclosed invention as set forth in the appended claims.

### BRIEF DESCRIPTION OF THE DRAWINGS

The invention will now be described in more detail and with reference to the appended claims in which:

FIG. 1, shows a communication system.

FIG. 2, shows the placement of the sensors and processors.

FIG. 3, shows the first predictor (20) data flow chart for detection of stiction, wear and tear and actuator degradation.

FIG. 4, shows second predictor (40) data flow chart for detection of valve leak.

### DETAILED DESCRIPTION OF THE INVENTION

At least one embodiment of the present invention is described below in reference to operation of a Shut Down Valve (SDV) within an oil and gas production plant. However, it should be apparent to those skilled in the art and guided by the teaching herein that the present invention is likewise applicable to any Emergency Shutdown Valve (ESDV) and any, Blow Down Valve (BDV) in any industrial facility that may employ SDV's, ESDV's or BDV's.

A non-exhaustive listing of possible industrial facilities that employ SDV'S, ESDV's or BDV's and that need to monitor such valves includes power generation plants, chemical facilities and electrical facilities. Those skilled in the art will further recognize that the teaching herein is suited to other applications in addition to industrial settings such as for example military, commercial and residential applications.

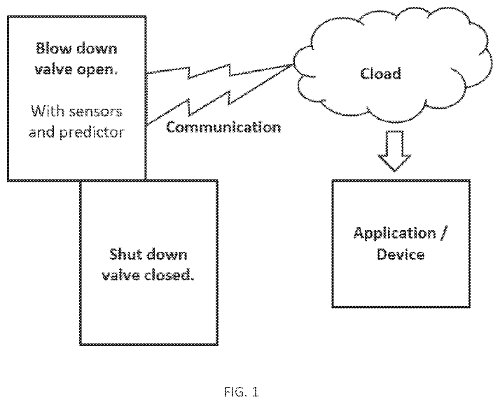

Referring to the drawings, FIG. 1 is a schematic illustration of a Shut Down Valve and a Blow Down Valve with monitoring system for abnormal situation detection depicting the communication as a generic symbol, achieved either over a Wi-Fi network, Bluetooth protocol, SMS protocol (a cloud, dedicated application or a handheld device), or any other applicable method according to one embodiment of the present invention. SDV's and/or BDV's with sensors and the Predictors are able to communicate with different recipients.

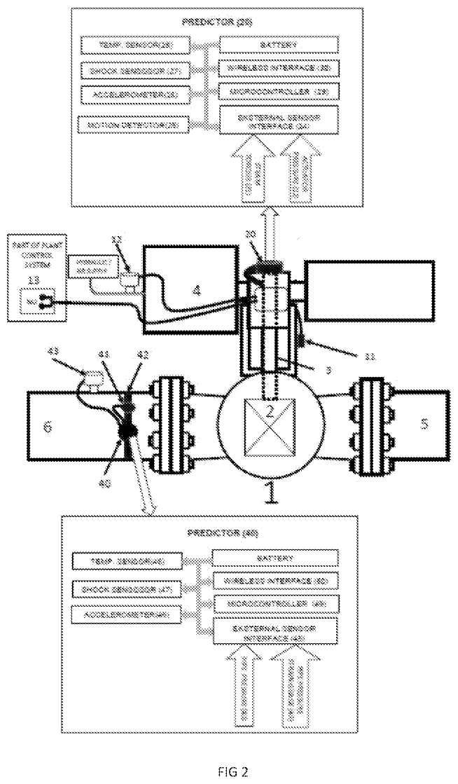

Referring to the drawing FIG. 2, shows the details of at least one SDV 1 with a first detector system comprising at least one first predictor 20 intended to record if the SDV's, flow-controlling element 2 sticks in closed or open valve position, also including:
a motion sensor 25 detecting rotational motion of the stem 3 to evaluate the degree of friction in said flow-controlling element 2, and/or
an accelerometer sensor 26 detecting rotational acceleration of the stem 3 to evaluate the degree of friction in the flow-controlling element 2, and/or
a shock sensor 27 detecting shock movement and/or ultrasonic vibration through the stem 3 and
a first microcontroller 29 controlling sensor data from the sensors 11, 12, 25, 26, 27, determining stiction of the said flow-controlling element 2, and
a first wireless interface 30 sending data emitting from said first microcontroller 29.

The said predictor 20 is fixed on top of the stem 3 and when the actuator 4 is activated, the flow-controlling element 2 move between open and closed position.

A second detector system comprising at least one second predictor 40 configurated to record and estimate leakage of the SDV's flow-controlling element 2 in closed position, is fixed to at least one downstream inlet pipe 5 and a downstream outlet pipe 6 on the said SDV 1, also including
a temperature sensor 48 detecting temperature in flow fluid, and/or
a second shock sensor 47 detecting shock movement in pipe 6, and/or
a second vibration sensor 46 detecting ultrasonic vibrations in the flow-controlling element 2, and/or
a second microcontroller 49 controlling the sensor data from the sensors 41, 46, 47, 48, determining flow rate, and
a second wireless interface 50 sending the data coming from said second microcontroller 49.

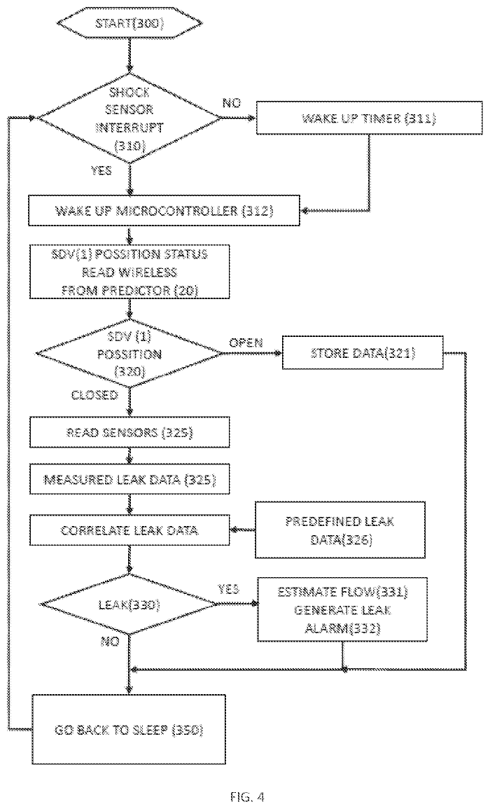

And where the second detector system also including at least one fastener 42 with at least one strain gauge sensor 41 is clamped to the downstream pipe 6 with the said fastener, where the pressure in the downstream pipe 6 expands the downstream pipe 6 and thereby increases the strain in the fastener 42 and the strain gauge sensor 41, and the measured strain that is proportional to the pressure in the downstream pipe 6 and/or at least one pressure sensor 43 which may be of piezoceramic type is installed in the downstream pipe 6 which also measures the pressure in the said downstream piping.

Where the said sensors 41 and 43 are wired onto the external sensor interface 45 which is controlled by the microcontroller 49 and measured as pipe pressure strain gauge 43 and pipe pressure 44, when the said microcontroller 49 wakes up from sleep mode as described in the flow chart FIG. 4.

Referring to FIG. 4, which illustrates the program steps for the said microcontroller 49, where START 300 is the initial sleep mode state of the microcontroller 49, and the at least one shock sensor 47 is installed in the Predictor 40 or at least one piezoelectric pressure sensor 43 is detecting sufficient ultrasonic vibrations energy transmitted from the downstream pipe 6 to generate an activation signal 310.

Where the microcontroller 49 wake-up 312, and communicate through the wireless interface 50 with the predictor 20 and receives the valve position data 320 for SDV 1, and if the flow-controlling element 2 is open, the program store the data with time 321 and goes back to sleep 350, but if the valve position 320 is closed the microcontroller 49 read and compute sensor data 325 from at least one of the said sensors 41, 43, 47, and accelerometer 46 and temperature sensor 48.

The microcontroller 49 then correlates the measured leak data 325 with a pre-defined leak data 326 and if the measured leak data 326 conforms with the pre-defined leak data 326, a leak is detected 330 and a leak flow is estimated 331 and a leak alarm 332 is generated and stored with real time and SDV 1 specific information in the microcontroller 49, and the microcontroller 49 can go back to sleep 350.

If the measured leak data 325 does not compare to a predefined leak data 326, no leak data is stored and the microcontroller 49 can go back to sleep 350 and wait for the above sequence from 312 to sleep 350 to be repeated by either the interrupt of the shock sensor 310 or wake-up call set by operational procedures to typically between 1 hour to 24 hours in the wake up timer 311.

Or where the predictor 20 intended to record if the flow-controlling element 2 sticks in closed or open valve position or where the said SDV is worn by wear and tear, where a plant-control system energizes or de-energizes the hydraulic or pneumatic pressure in the actuator 4 monitored by the actuator pressure sensor 12 and the movement of the actuator 4 turns the stem 3 to open or close the flow-controlling element 2.

The plant-control system while energizing or de-energizing the hydraulic or pneumatic pressure in the actuator 4, intermittently closes a normally open contact valve control 13 and where at least one strain gauge sensor 11 measures the dynamic force induced on the flow controlling element 2 by the rotational torque generated by the actuator 4 and where the sensor cable 15 from strain gauge sensor 11 and the sensor cable 16 from actuator pressure sensor 12 and the sensor cable 17 from remote valve control 13 may be connected in junction box 14 and wired through multi-sensor cable 18 or alternatively sensor cable 15, 16 and/or 17 be connected to the predictor 20.

External sensor interface 24 which is controlled by the microcontroller 29, will read the signal from the strain gauge sensor 11 and detect the stem torque 21 and the signal from the actuator pressure sensor 12 to the actuator pressure 22 and the signal from the remote valve control 13 to the actuator trigger 23.

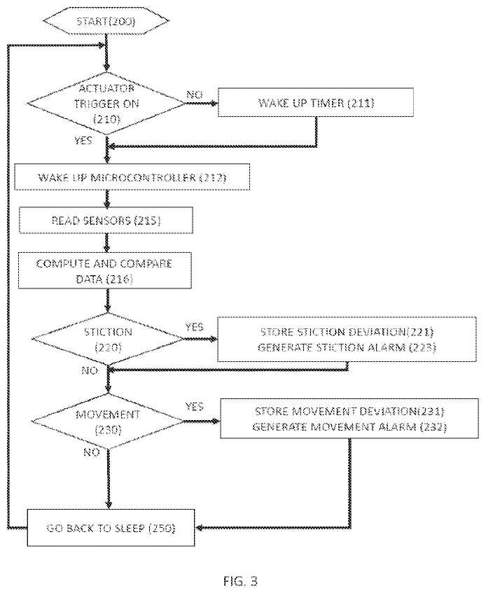

And where a change of state in at least one actuator triggers 23 awake the microcontroller 29 to wake-up from sleep mode which is further described in the flow chart in FIG. 3, which illustrates the program steps for the said microcontroller 29, where START 200 is in the initial sleep mode state of the microcontroller 29 and at least one actuator trigger 210 generate an activation signal where the microcontroller 29 wake up 212 and reads sensor data 215 from the sensors 11 and 12, motion sensor 25, accelerometer sensor 26, shock sensor 27 and temperature sensor 28. And microcontroller 29 transmit said sensor signals through the wireless interface 30 through the wireless interface 50 to the microcontroller 49 which then reads computed sensor data 325 from at least one of the said sensors 41, 43, 47, accelerometer sensor 46 and temperature sensor 48 and then the microcontroller 49 correlate the measured leak data 325 with a pre-defined leak data 326. If the measured leak data 326 conforms with the pre-defined leak data 326 a leak is detected 330 and a leak flow is estimated 331 and a leak alarm 332 generated and data is stored with real time. The SDV 1 specific information is stored in the microcontroller 49, and the microcontroller 49 can go back to sleep 350.

If the measured leak data 325 does not compare to a pre-defined leak data 326, no leak data is stored and the microcontroller 49 can go back to sleep 350 and wait for the above sequence from 312 to 350 to be repeated by either the interrupt of the shock sensor 310 or wake-up call set by operational procedures to typically between 1 hour to 24 hours in the wake-up timer 311 and the microcontroller 29 reads sensor data 215 from at least one of the said sensors 11, 12, 25, 26, 27 and 28.

The microcontroller 29 then compute the measured stiction data 216 and compare with the pre-defined acceptable stiction data 220 which define the conditions for acceptable stiction in SDV 1 and therefore if correlation of stiction data 221 is outside acceptable limits, stiction deviation data 222 is stored and a stiction alarm 223 is generated and stored with real time SDV 1 specific information in the microcontroller 29.

If the measured stiction data 216 does not compare to a pre-defined stiction data set 220 no stiction deviation is detected and the microcontroller 29 compute the measured movement data set 217 and compare with the pre-defined acceptable movement data 230 which defines the conditions for acceptable movement of the flow-controlling element 2 and therefore if correlation of movement data 231 is out of acceptable limits due to wear and tear or other actuator problems, movement deviation data 231 is stored and a movement alarm 223 is generated and stored with real time and SDV 1 specific information in the microcontroller 29.

If the measured movement data 217 does not compare to a pre-defined movement data 230 no movement deviation is detected and the microcontroller 29 goes back to sleep 350 and wait for the above sequence from wake-up timer 212 to sleep-mode 250 to be repeated by either the interrupt of the actuator trigger 210 or wake-up call set by operational procedures, typically between 1 hour to 24 hours in the wake-up timer 211.

1-15. (canceled)

16. A system for detecting abnormal operating conditions in a shutdown valve, the system comprising:
an inlet pipe and an outlet pipe;
a flow-controlling element located between the inlet and outlet pipes;
a stem connected to the flow-controlling element and driven by an actuator arrangement;
a first detector system for detecting stiction of the flow-controlling element, the first detector system including a first predictor connected to the stem for detecting the position of the flow-controlling element transferred through the stem with at least one sensor of the group consisting of a motion sensor, an acceleration sensor, or a shock sensor; and
a second detector system for detecting a leak in the flow-controlling element, the second detector system including a second predictor for detecting vibrations in the flow-controlling element.

17. A system according to claim 16, wherein the second predictor is connected to the outlet pipe.

18. A system according to claim 16, wherein the motion sensor detects rotational motion of the stem, the acceleration sensor detects rotational acceleration of the stem, and the shock sensor detects shock movement and or ultrasonic vibration through the stem,
and wherein the first predictor includes a first microcontroller monitoring sensor data from the sensors and a first wireless interface for sending data coming from the first microcontroller.

19. A system according to claim 16, wherein the second predictor includes at least one sensor in the group consisting of (i) a temperature sensor for detecting temperature in a flow fluid, (ii) a second shock sensor for detecting shock movement or ultrasonic vibrations in the outlet pipe, and (iii) a second vibration sensor for detecting vibrations in the flow-controlling element,
and wherein the second predictor includes a second microcontroller monitoring sensor data from the sensors and a second wireless interface for sending data coming from the second microcontroller.

20. A system according to claim 16, further including a strain gauge sensor for detecting dynamic force induced on the stem.

21. A system according to claim 16, further including an actuator pressure sensor for detecting hydraulic pressure in the actuator arrangement.

22. A system according to claim 16, further including a strain gauge sensor clamped with a fastener on the wall of the outlet pipe, the strain gauge sensor for detecting strain in the fastener proportional to pressure.

23. A system according to claim 16, further including a second pressure sensor located on an outlet side of the flow controlling element for detecting fluid pressure in the outlet side of the flow controlling element.

24. A method for detecting abnormal operating conditions in a shutdown-valve system, the shutdown-valve system comprising an inlet pipe, an outlet pipe, a flow-controlling element located between the inlet and outlet pipes, a stem connected to the flow-controlling element and driven by an actuator arrangement, the method comprising:
detecting stiction of the flow-controlling element by detecting the position of the flow-controlling element transferred through the stem with at least one sensor, the at least one sensor being a position sensor, an acceleration sensor, or a shock sensor; and
detecting a leak in the flow-controlling element by detecting vibrations in the flow-controlling element.

25. A method according to claim 24, further including:
if a deviation of the stiction of the flow-controlling element is determined, generating a stiction alarm and storing stiction deviation data;
if no deviation of the stiction of the flow-controlling element is determined, but a deviation of movement of the flow-controlling element is determined, generating a movement alarm and storing movement deviation data; and
if no deviation of movement and no deviation of the stiction is determined, causing a microcontroller of the system to enter a sleep mode.

26. A method according to claim 25, wherein the system includes a first detector system for detecting stiction of the flow-controlling element, the first detector system including a first predictor connected to the stem for detecting the position of the flow-controlling element transferred through the stem with a position sensor, an acceleration sensor, or a shock sensor, and the method further comprises
causing the microcontroller to wake-up from the sleep mode in response an actuator trigger signal coming from the first predictor.

27. A method according to claim 25, further comprising causing the microcontroller to wake-up from the sleep mode in response a wake-up timer.

28. A method according to claim 24, the system includes a first detector system for detecting stiction of the flow-controlling element, the first detector system including a first predictor connected to the stem for detecting the position of the flow-controlling element transferred through the stem with a sensor, the first predictor has a first microcontroller that communicates the valve position data for the flow-controlling element to a second microcontroller, wherein the method further includes:
i. if the position of the flow controlling element indicates that the valve is open, storing the data;
ii. if the position of the flow controlling element indicates that the valve is closed,
reading sensor data, by use of the second microcontroller, from a temperature sensor, a second shock sensor, a second vibration sensor, a strain gauge sensor, or a second pressure sensor, the sensor data is correlated with pre-defined leak data;
estimating leak flow;
generating a leak alarm;
storing the data; and
causing the system to enter a sleep mode.

29. A method according to claim 28, wherein causing the second microcontroller to wake up from the sleep mode in response to a shock sensor signal coming from the second shock sensor.

30. A method according to claim 28, further comprising causing the second microcontroller to wake-up from the sleep mode in response a wake-up timer.

31. A method for automatic, unattended online verification of the safety performance of a shutdown valve in a live process while the shutdown valve is activated by a remote-control signal to perform a safeguarding action, the shutdown valve comprising an inlet pipe and an outlet pipe, a flow controlling element with a stem connected to and driven by an actuator, a first detector system fixed to the stem including a first predictor with a first microcontroller, a motion sensor, an accelerometer sensor, and a first shock sensor, the first detector system (i) detecting stiction, friction, position, and vibrations of the flow controlling element through the stem, (ii) detecting stem torque induced in the stem by use of an external strain gauge sensor, or (iii) detecting actuator pressure in the actuator by use of an external actuator pressure sensor,
wherein the first predictor is adapted to transmit the position of the flow controlling element to a second predictor having a second microcontroller, and at least one sensor in the group consisting of (i) a second shock sensor detecting leakage flow in the flow controlling element, (ii) a temperature sensor detecting temperature of fluid flow, (iii) an external pressure sensor detecting fluid pressure in the outlet pipe, and (iv) a strain gauge sensor clamped to the outlet pipe for detecting fluid pressure in the outlet pipe;
and wherein the method includes:
a) computing dynamic movement data and stiction data from the sensors of the first detector system;
b) comparing the computed stiction data with predefined acceptable stiction data, and if the computed stiction data is out of an acceptable range, storing stiction deviation data and generating a stiction alarm; and
c) comparing dynamic movement data with predefined acceptable movement data, and if computed dynamic movement data is out of an acceptable range, storing movement deviation data and generating a movement alarm.

32. A method according to claim 31, where the second predictor reads and computes sensor data for the purpose of detecting a possible leak and determining a leak flow when the flow controlling element is in closed position,
and wherein the method further includes:
computing leak flow data,
correlating computed leak flow data with predefined acceptable leak flow data,
if the computed leak data is out of predefined range, estimating a leak flow and generating a leak flow alarm.

33. A method according to claim 31, wherein the second shock sensor or a wake-up timer is adapted to wake up the first and second predictors and the first and second predictors return to a sleep mode when the procedure is terminated.
